(19) United States
(12) Patent Application Publication
(10) Pub. No.: US 2008/0066583 A1
(43) Pub. Date: Mar. 20, 2008

(54) Flange wrench

(76) Inventor: Glenn D. Lott, White Oak, TX (US)

Correspondence Address: THE MATTHEWS FIRM, 2000 BERING DRIVE, SUITE 700, HOUSTON, TX, 77057, US

(21) Appl. No.: 11/894,064

(22) Filed: Aug. 20, 2007

Related U.S. Application Data
(60) Provisional application No. 60/814,208, filed on Aug. 21, 2006.

(51) Int. Cl. B25B 13/02

(52) U.S. Cl. 81/120

(57) ABSTRACT

A flange wrench for tightening and loosening pipe flanges onto/off of pipes has a drive head and an elongate handle. The drive head has a flat planar surface essentially parallel to a longitudinal axis of the wrench handle, and a pin extending therefrom essentially normal to the plane of the essentially planar surface. The head also includes a first essentially planar shoulder surface that is adjacent to and generally normal to the first planar mating surface, such that the planar shoulder surface is generally parallel to the axis of the pin. To use the flange wrench, the user inserts the pin into an existing or drilled mounting hole in the flange and positions the wrench planar mating surface against the planar surface of the flange such that the flange wrench planar shoulder surface is adjacent the circumferential edge of the flange. By rotating the flange wrench handle about the axis of the pipe (and therefore the axis of the flange), the wrench head planar shoulder surface bears against the flange circumferential edge, thereby causing the wrench torque to be transferred to and about the pipe longitudinal axis in order to tighten/loosen the flange onto/off of the pipe.

### CROSS-REFERENCE TO RELATED APPLICATIONS

This application claims priority to U.S. Provisional Application No. 60/814,208, filed Aug. 21, 2006, entitled Flange Wrench, and which is incorporated herein by reference for all purposes.

### STATEMENT REGARDING FEDERALLY-SPONSORED RESEARCH OR DEVELOPMENT

Not applicable.

### FIELD OF THE INVENTION

The present invention relates to wrenches, and more specifically to a flange wrench specifically adapted to tighten and loosen pipe flanges onto/off of pipes.

### BACKGROUND OF INVENTION

Pipe flanges are commonly threadedly attached to pipes for various reasons, primarily to attach pipes together or to attach a pipe to a mating flange on a fluid valve, manifold, elbow, “T”, pressure gauge, etc. In order to tighten/loosen such a flange onto/off of the pipe, typically a pipe flange is attached to the valve, manifold, etc. for stability, followed by threadedly engaging the pipe into the flange. In instances where the flange must be attached to or removed from the pipe without attaching the flange to a valve, manifold, etc., it has been typical for the user to insert two bolts in diametrically opposed mounting holes in the flange, then use a long, smaller pipe or rod (a “cheater” bar) placed diametrically across the flange and against the two bolts in order to “urge” the flange in one direction or the other to tighten/loosen the flange.

### DESCRIPTION OF DRAWINGS

FIG. 1 is a perspective view of a first embodiment of the flange wrench of the present invention.

FIG. 2 is a plan view of the flange wrench attached to a flange and illustrating the mechanics of operation of the flange wrench.

FIG. 3 is a perspective view of a second embodiment of the flange wrench of the present invention.

FIG. 4 is a perspective view of a third embodiment of the flange wrench of the present invention.

FIG. 5 is a plan view of the head of the flange wrench of FIG. 4.

FIG. 6 is a plan view of a pin utilized in the flange wrench of FIGS. 3 and 4.

### DESCRIPTION OF INVENTION

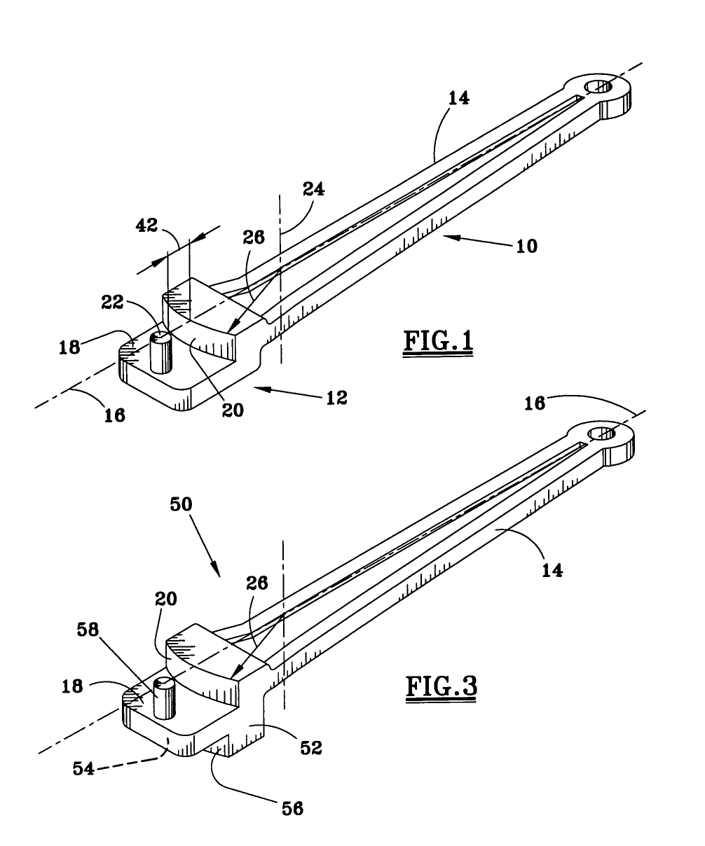

Turning now the drawings and initially to FIG. 1, a first embodiment of a flange wrench of the present invention is shown generally illustrated at 10. The flange wrench 10 comprises a head 12 attached to or formed with an elongate handle 14. The elongate handle 14 is typical of wrenches and specifically pipe wrenches, and includes a longitudinal axis 16.

The flange wrench head 12 comprises a body defining a planar surface 18 for engaging the flat planar surface of a pipe flange, as will be described in greater detail hereinbelow. The flange wrench head body also includes an essentially planar shoulder surface 20 essentially normal to the wrench head planar surface 18 for engaging the circumferential surface 34 of a pipe flange, as will be described in greater detail hereinbelow. The flange wrench head also includes a pin 22 extending from the head body planar surface 18 normal thereto and aligned with the elongate handle longitudinal axis. As will be described in greater detail hereinbelow, the pin 22 is dimensioned to fit into a flange mounting hole, and is spaced from the head body essentially planar shoulder surface 20 by a distance slightly greater than the distance of the flange mounting hole to the circumferential surface of the flange. In one embodiment, the flange wrench head body essentially planar shoulder surface 22 is slightly arcuate about a center axis 24 as shown by arrow 26 in FIG. 1. The purpose of this arcuate shoulder surface will be described in greater detail hereinbelow.

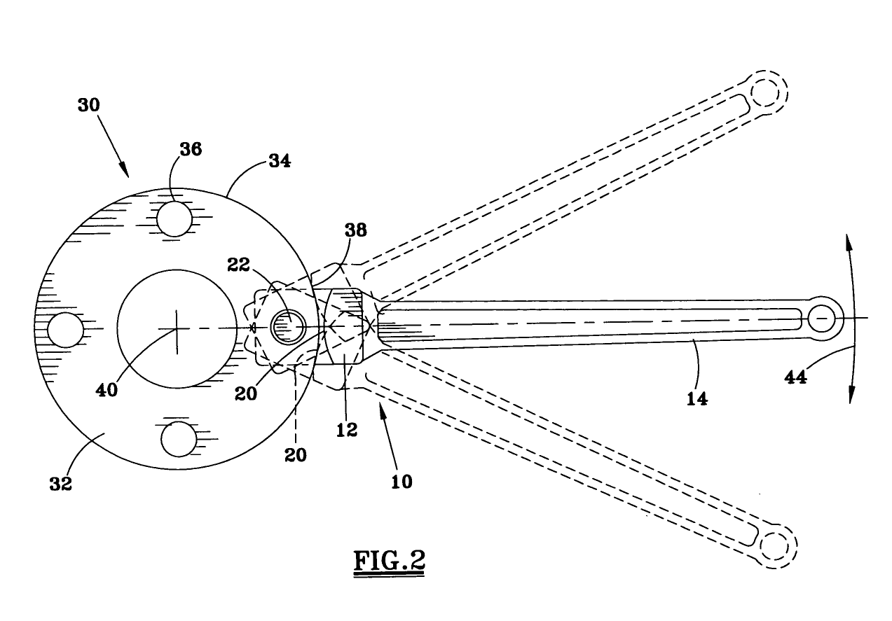

FIG. 2 illustrates the operation of the flange wrench of the present invention. A flange 30 typically comprises a flat planar surface 32 having a circumferential edge 34. Mounting holes 36 are provided in the flange for accepting bolts, studs, etc. for attaching the flange to a fluid valve, manifold, elbow, “T”, pressure gauge, etc, and thereafter threadedly attaching the pipe into the flange.

To use the flange wrench 10 of the present invention, the user inserts the flange wrench pin 22 into a flange mounting hole 36, such that the flange wrench head planar surface 18 engages one or the other flat planar surface 32 of the flange. In FIG. 2, the flange wrench 10 is shown inserted into the flange from the opposite (far) side, such that the flange wrench pin 22 faces out and is clearly shown in the flange mounting hole 36, and the wrench head planar surface 18 engages the backside of the flange, opposite the flange flat planar surface 32 visible in FIG. 2.

Initially, the flange wrench 10 is attached to the flange by aligning the flange wrench handle 14 with a radius or diameter of the flange passing through one of the flange mounting holes 36, then pressing the flange wrench head pin into the mounting hole until the flange wrench head planar surface 18 firmly and securely engages a flat planar surface of the flange. With the wrench 10 so-attached to the flange 30, the user then pivots the wrench handle appropriately (clockwise or counterclockwise about the flange wrench pin 22) to cause the wrench head essentially planar shoulder surface 20 to bear against the flange circumferential edge 34, as shown in dotted lines in FIG. 2. As shown, the flange wrench head essentially planar shoulder surface 20 bears against the flange circumferential edge 34 at a line of engagement 38. Those skilled in the art will appreciate that, initially, the flange wrench 10 pivots about the wrench head pin 22 until the planar shoulder surface 20 engages the flange circumferential edge 34, at which time further urging of the wrench handle in the appropriate direction will transfer the wrench moment of rotation from the wrench head pin 22 to the central axis 40 of the flange 30 and pipe (not shown), thereby appropriately tightening or loosening the flange onto/from the pipe.

Those skilled in the art will readily appreciate that the line of contact of engagement 38 of the wrench shoulder surface 20 and the flange circumferential surface 34 will be dependent upon the distance between the edge of the pin 22 and the wrench head planar shoulder surface 20, as shown in FIG. 1 at 42. Understandably, the shorter the distance 42, the closer the line of engagement 38 between the wrench shoulder surface 20 and flange circumferential surface 34 will be to the elongate handle longitudinal axis 16. Also understandably, with reference again to FIG. 2, the closer the line of engagement 38 of the wrench shoulder surface 20 to the flange circumferential surface 34 is to the elongate handle longitudinal axis 16, the closer the flange wrench elongate handle 14 will be to a radius/diameter of the flange and pipe, thereby providing maximum torque applied directly to the flange. Therefore, it is advantageous for the flange wrench 10 of the present invention to be designed to fit specific flanges, in terms of (1) the size of the pin 22 relative to that of the flange mounting hole 36, and also (2) the distance 42 (shown in FIG. 1) between the flange wrench pin 22 and the planar shoulder surface 20.

In addition, in the various flange wrench embodiments shown and described, the essentially planar shoulder surface 20 is slightly arcuate about the center axis 24 as shown by arrow 26 in FIG. 1. In this manner, the line of engagement 38 (FIG. 2) of the flange wrench head essentially planar shoulder surface 20 and the flange circumferential edge 34 is assured to be between two arcuate surfaces (the flange circumferential edge 34 and the wrench head essentially planar shoulder surface 20), as opposed to, for example, between the flange circumferential edge 34 and a sharp corner formed at the intersection of a straight wrench head shoulder surface and the side of the wrench head. Those skilled in the art will readily appreciate that the engagement of these two arcuate surfaces creates an “area” of contact over which to distribute the substantial force applied to shoulder surface, as opposed to a “point” of concentrated force between the shoulder surface and the flange circumferential edge. Obviously, however, the wrench head essentially planar shoulder surface 20 could be designed to be a straight, flat surface without detracting from the spirit of the present invention.

The flange wrench of the present invention has been illustrated and described (for purposes of clarity) to be functionally attached to the back face of the flange 30 in order to better illustrate and describe the attachment and the function (the engagement 38 of the wrench shoulder surface 20 with the flange circumferential surface 34) of the wrench on the flange. Those skilled in the art will readily appreciate that the flange wrench of the present invention will readily attach to either planar face (front 32 shown in FIG. 2 or the rear face (not shown)) with equal effectiveness for both tightening and loosening the flange onto/off of the pipe.

Those skilled in the art will also readily appreciate that the flange wrench of the present invention can be used to tighten/loosen a flange onto/off of a pipe without removing the wrench pin 22 from the flange mounting hole 36 and repositioning the wrench on the flange, as is required in prior art flange wrenches and methods of tightening/loosening flanges onto/off of pipes. This is illustrated by arrow 44 in FIG. 2.

A second embodiment 50 of the flange wrench of the present invention is shown in FIG. 3. The second embodiment wrench 50 of FIG. 3 is a dual wrench, having two sides (opposite from each other) that are identical in design and function, but not dimension, to the first embodiment 10 shown in FIG. 1. Those skilled in the art will appreciate that the second embodiment 50 of the flange wrench of the present invention includes a handle 14 and a drive head 52. The drive head 52 comprises, in addition to the first planar surface 18 of the first embodiment, a second planar surface 54 on the opposite side thereof, and, in addition to the first essentially planar shoulder surface 20, a second essentially planar shoulder surface 56, likewise on the opposite side of the head and essentially normal to the second planar surface 54. In addition, this second embodiment 50 includes a modified pin 58 (better illustrated in FIG. 6) having a first larger diameter 60 and a second smaller diameter 62. Those skilled in the art will appreciate that (1) the side of the second embodiment flange wrench 50 (the bottom side shown in FIG. 3) has the pin second smaller diameter 62 extending from the second planar surface 54, coupled with a shorter distance from the pin second smaller diameter 62 to the second essentially planar shoulder surface 56 for accommodating a smallerflange having smaller mounting holes 36 and a shorter distance from the edge of the mounting holes to the circumferential surface 34. In this manner, the second embodiment flange wrench 50 of FIG. 3 can be utilized with two different sizes/configurations of flanges. And by reversing the pin 22, the second embodiment flange wrench 50 can be utilized with four different sizes/configurations of flanges, assuming, of course, that the alternate size pin will fit in the flange mounting hole. Again, the critical distance is the distance between the closest edge of the pin and point of contact of the flange circumferential surface to the wrench planar shoulder surface. Also again, this line of contact will not be co-linear with the wrench longitudinal axis 16.

The wrench of the present invention operates by creating a moment arm initially about the pin 22 in the flange mounting hole 36, until the wrench shoulder surface 20 engages the flange circumferential edge 34, at which point the wrench moment arm is transferred to the longitudinal axis 40 of the flange and pipe to rotate the flange onto/off of the pipe. Those skilled in the art will readily appreciate that the flange mounting hole can be located anywhere on the flange (even drilled into the flange solely for the purpose of attaching the flange wrench), as long as the mounting hole is not coincident with the flange center axis/pipe longitudinal axis 40, and the flange wrench of the present invention will function to rotate the flange relative to the pipe.

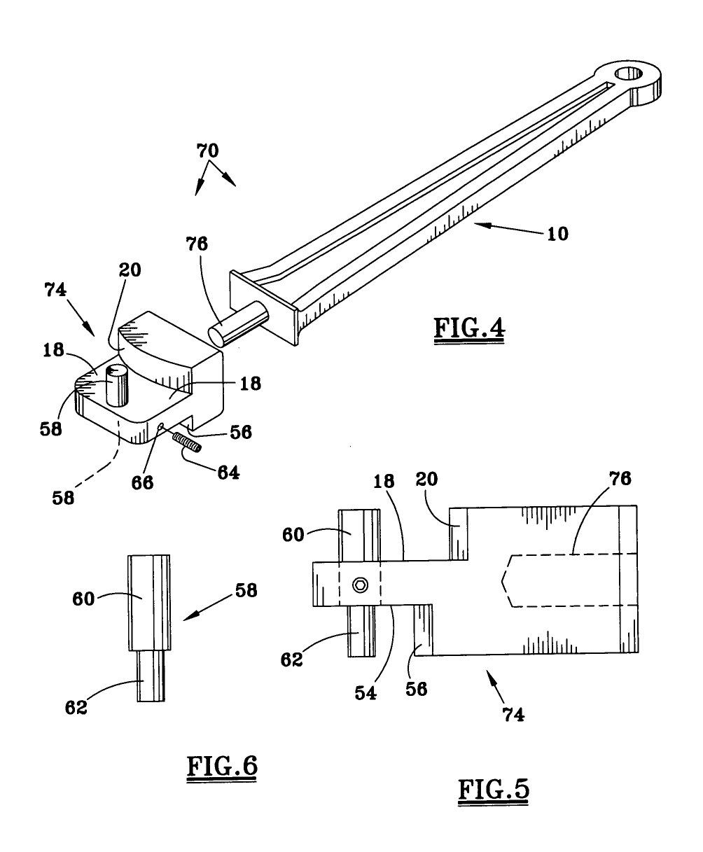

The flange wrench of the present invention can be constructed of a unitary piece, typical of pipe wrenches, etc. In addition, however, a third embodiment 70 of the flange wrench of the present invention can be constructed of two separate pieces, a separate longitudinal handle 72 and head 74, as shown in FIG. 4. In this embodiment 70, the head 74 includes first and second planar surfaces 18, 58 and first and second essentially planar shoulder surfaces 20, 56, and a modified pin 58, as in the second embodiment 50 shown in FIG. 3. Having a 2-piece flange wrench design, however, enables the wrench to be made out of dissimilar materials for economical purposes. Specifically, the head 74 of the third embodiment of FIG. 4 can be made of 40-41 steel machined to the configuration shown, and the handle 72 can be a casting of a less-expensive-to-manufacture steel. In this embodiment, the handle 72 is attached to the head 74 by a threaded stud 76 that is threaded into respective holes along the longitudinal axis of the handle 72 (not shown) and formed and tapped into the head 74 (shown in FIG. 5 at 76). In this manner, the third embodiment flange wrench 70 of FIG. 4 can be manufactured much more economically and also, is much more durable and robust by having the head and pin made of a much stronger steel than that of the handle.

Again referring to FIG. 4, the modified pin 58 can be held in the head 74 of the flange wrench of FIGS. 3 and 4 by a set screw 64 screwed into tapped hole 66 in a customary manner to retain the pin 58 in functional position within the flange wrench head. In this manner, the set screw 64 can be loosened and the modified pin 58 easily reversed for the alternative flange wrench head configurations, as previously discussed.

What is claimed is:

1. A wrench comprising:
an elongate handle having a longitudinal axis; and
a head mounted with said handle, said head having:
a first planar mating surface essentially parallel to said handle longitudinal axis;
a first essentially planar shoulder surface adjacent and generally normal to said first planar mating surface, and facing away from said handle; and
a pin having a longitudinal axis mounted with said first planar mating surface, normal to said first planar mating surface and extending therefrom.

2. A wrench as set forth in claim 1, wherein said first essentially planar shoulder surface is generally perpendicular to said handle longitudinal axis.

3. A wrench as set forth in claim 1, wherein said first essentially planar shoulder surface is slightly arcuate about a center line passing through said handle longitudinal axis and parallel to the longitudinal axis of said pin.

4. A wrench as set forth in claim 1, further comprising a second planar mating surface and second essentially planar shoulder surface, and wherein said pin passes through said head and extends from said first and second planar mating surfaces generally normal thereto.

5. A wrench as set forth in claim 4, wherein said pin is a stepped-diameter pin such that different diameters extend from said first and second planar mating surfaces.

6. A wrench as set forth in claim 1, wherein said handle and said head are formed of a unitary piece.

7. A wrench as set forth in claim 1, wherein said handle and said head are formed of separate pieces that are attached together to form said wrench.

8. A wrench as set forth in claim 7, wherein said handle and said head are formed of dissimilar materials.

9. A method of tightening/loosening a flange onto/off of a pipe, comprising:
providing a wrench comprising:
an elongate handle having a longitudinal axis; and
a head mounted with said handle, said head having:
a first planar mating surface essentially parallel to said handle longitudinal axis;
a first essentially planar shoulder surface adjacent and generally normal to said first planar mating surface, and facing away from said handle; and
a pin having a longitudinal axis mounted with said first planar mating surface, normal to said first planar mating surface extending therefrom;
inserting the wrench pin into a mounting hole in the flange;
positioning the wrench first planar mating surface against a mating planar surface of the flange; and
pivoting the wrench about a center axis of the flange.

10. The method as set forth in claim 9, further comprising pivoting the wrench about the pin longitudinal axis until the wrench essentially planar shoulder surface engages a circumferential edge of the flange.

11. A wrench for rotating a rotatable object having a first surface that is at least partially planar and within a plane normal to the axis of rotation of the object and a perimeter surface adjacent and normal to the partially planar surface, said wrench comprising:
an elongate handle having a longitudinal axis;
a head mounted with an end of said handle, said head having a first generally planar surface essentially parallel to said handle longitudinal axis and a second generally planar surface adjacent and generally normal to said first generally planar surface and generally normal to said handle longitudinal axis; and
an attachment mechanism mounted with said first generally planar surface.

12. A wrench as set forth in claim 11, wherein said second generally planar surface is generally perpendicular to said handle longitudinal axis.

13. A wrench as set forth in claim 11, wherein said attachment mechanism comprises a pin having a longitudinal axis.

14. A wrench as set forth in claim 13, wherein said second generally planar surface is slightly arcuate about a center line passing through said handle longitudinal axis and generally parallel to the longitudinal axis of said pin.

15. A wrench as set forth in claim 13, further comprising a third generally planar surface and a fourth generally planar surface, and wherein said pin passes through said head and extends from said first and third generally planar surfaces generally normal thereto.

16. A wrench as set forth in claim 15, wherein said pin is a stepped-diameter pin such that different diameters extend from said first and third generally planar surfaces.

17. A wrench as set forth in claim 11, wherein said handle and said head are formed of a unitary piece.

18. A wrench as set forth in claim 11, wherein said handle and said head are formed of separate pieces that are attached together to form said wrench.

19. A wrench as set forth in claim 18, wherein said handle and said head are formed of dissimilar materials.
